(19) United States
(12) Patent Application Publication
(10) Pub. No.: US 2004/0254978 A1
(43) Pub. Date: Dec. 16, 2004

(54) System and method of remotely accessing a computer system to initiate remote mainteneance and management accesses on network computer systems

(75) Inventors: Jesus Gerardo Ibanez, Austin, TX (US); Neil A. Taylor, Pflugerville, TX (US); P. G. Ramachandran, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 10/460,429

(22) Filed: Jun. 12, 2003

(51) Int. Cl. G06F 15/16

(52) U.S. Cl. 709/203

(57) ABSTRACT

A system, apparatus and method of accessing a remote computer system to initiate maintenance and management accesses on remote network computer systems are provided. A device is used to access the remote computer system. The device uses a Web service to gain access to the remote computer system as well as to instruct the remote computer system to initiate a maintenance and management access on a remote network computer system. In a particular embodiment, the interaction between the device and the remote computer system occurs through a Web browser. Further in cases where the network computer system is off, Wake-On-LAN (WOL) technology is used to turn the network computer system on. In addition, if the network computer system does not have an operating system (OS) installed thereon, Pre-boot Execution Environment (PXE) bootstrapping technology is used to download an image of an OS to the network computer. After the network computer is up and running it may be instructed to perform different tasks (e.g., running diagnostic tests, virus scans, self-install software packages and their updates etc.)

### BACKGROUND OF THE INVENTION

1. Technical Field

The present invention is directed to network computer system management and maintenance. More specifically, the present invention is directed to a system and method of remotely accessing a computer system to initiate remote maintenance and management accesses on network computer systems.

2. Description of Related Art

Most modern computer systems (e.g., personal computers or PCs) come with a network interface card (NIC) that supports Wake-On-LAN (WOL) technology. WOL provides a remote wake-up feature that, combined with other remote control capabilities (e.g., control capabilities available from management agents such as Tivoli Management Agent (TMA) a product of IBM Corp.) gives technicians the ability to turn computer systems on remotely and automatically during off-hours to perform maintenance activities.

In order to be remotely turned on, a WOL-enabled computer system has its NIC, which is connected to a network, powered via an alternate power source. Thus, when the computer system is turned off, its NIC may continue to monitor the network for a WOL packet (e.g., the computer system's media access control (MAC) address repeated six times). When the NIC receives the proper WOL packet, it turns the computer system on. The computer system, at that point, will go through its normal startup sequence. For example, if the computer system does not have an operating system (OS) installed thereon and the computer system's NIC supports Pre-Boot Execution Environment (PXE), which is supported by most WOL-enabled computer systems, then the computer system's normal startup sequence will encompass the scenario described below so long as it is configured to be booted up over the network. (PXE allows a workstation to boot from a server on a network prior to having an operating system installed thereon.)

When the computer system is turned on by its NIC, it will begin its hardware boot. Once the hardware boot is terminated, the software boot will begin. At that point, PXE will take over. As soon as PXE is running on the client, it will look for a Dynamic Host Configuration Protocol (DHCP) server. The DHCP server will provide the computer system with a network bootable image (NBI) of an OS, which the client may use to bootstrap itself. After the network OS boot, the computer system may be instructed to perform maintenance tasks. For example, the computer system may be directed to run utilities such as virus scan or disk backup, to install an operating system or other software packages as well as performing software upgrades etc. After performing the maintenance tasks the computer system may be instructed to turn itself off again.

These remote maintenance accesses allow companies to save time on software installations and upgrades and increase end-user productivity by avoiding disruptions during work hours. However, although a system administrator need not be on location to maintain and manage a network computer system, the system administrator nonetheless needs to be at a remote computer system where the remote commands are issued. It is inevitable that sometimes the system administrator may not be physically at that remote computer system and thus may be unable to initiate a remote maintenance and management access on a network computer system.

Hence, a system and method of accessing a remote computer system remotely to initiate remote maintenance and management accesses on network computer systems are needed.

### SUMMARY OF THE INVENTION

The present invention provides a system, apparatus and method of accessing a remote computer system remotely to initiate maintenance and management accesses on remote network computer systems. A device is used to access the remote computer system remotely. The device uses a Web service to gain access to the remote computer system as well as to instruct the remote computer system to initiate a maintenance and management access on a remote network computer system. In a particular embodiment, the interaction between the device and the remote computer system occurs through a Web browser. Further in cases where the network computer system is off, Wake-On-LAN (WOL) technology is used to turn the network computer system on. In addition, if the network computer system does not have an operating system (OS) installed thereon, Pre-boot Execution Environment (PXE) bootstrapping technology is used to download an image of an OS to the network computer. After the network computer is up and running it may be instructed to perform different tasks (e.g., running diagnostic tests, virus scans, self-install software packages and their updates etc.)

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a block diagram of a computing system using Web services technology in accordance with the invention.

FIG. 5 illustrates a representative Web service interacting with a client.

FIG. 6 is a flow chart of a process that may be used by a Web service to perform the invention.

FIG. 7 is a flow chart of a process that may be used by a server in accordance with the invention.

### DETAILED DESCRIPTION OF THE PREFERRED EMBODIMENT

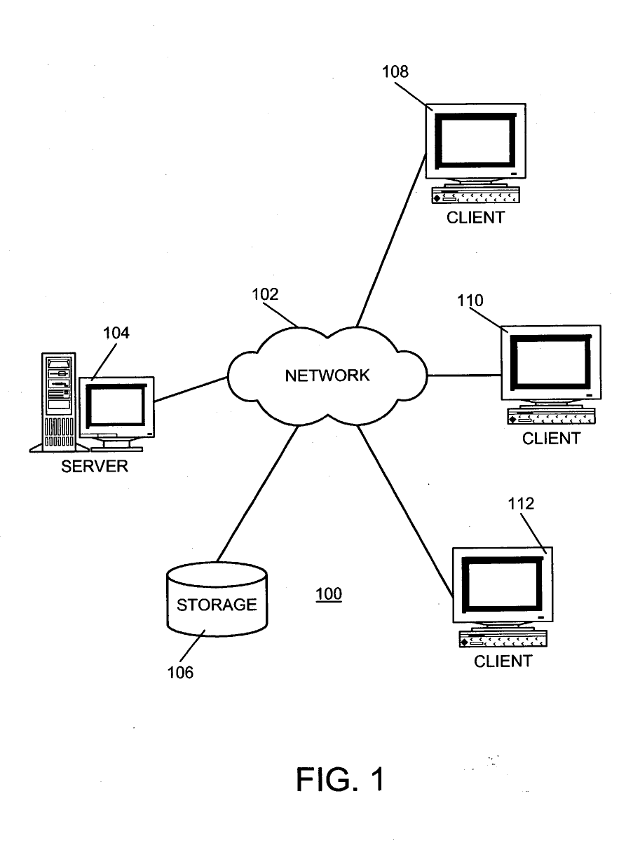

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

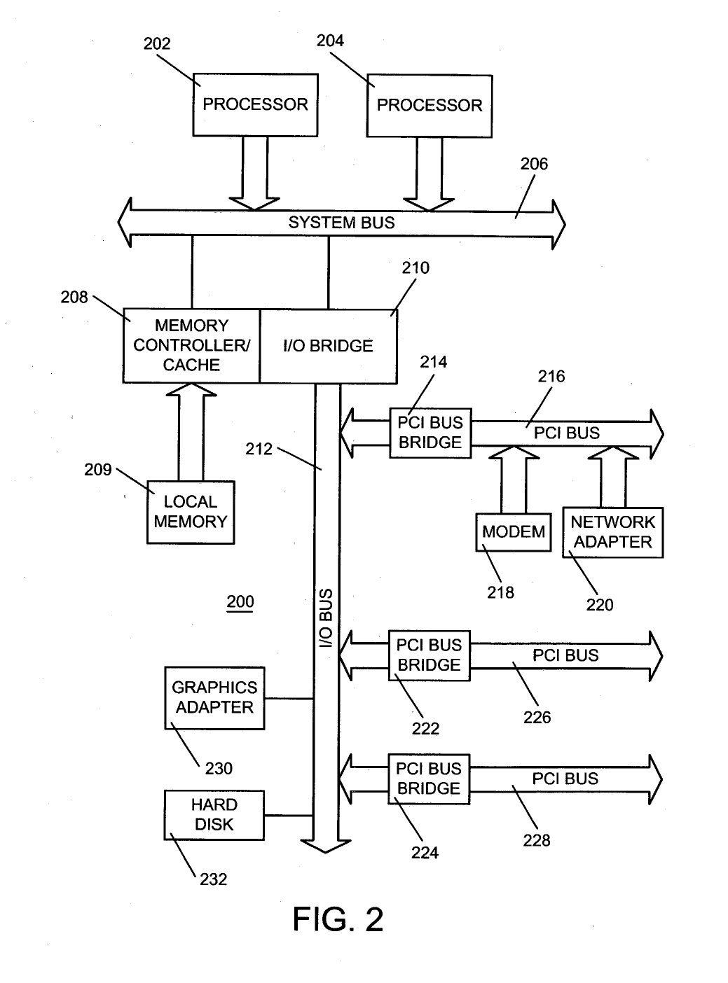

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

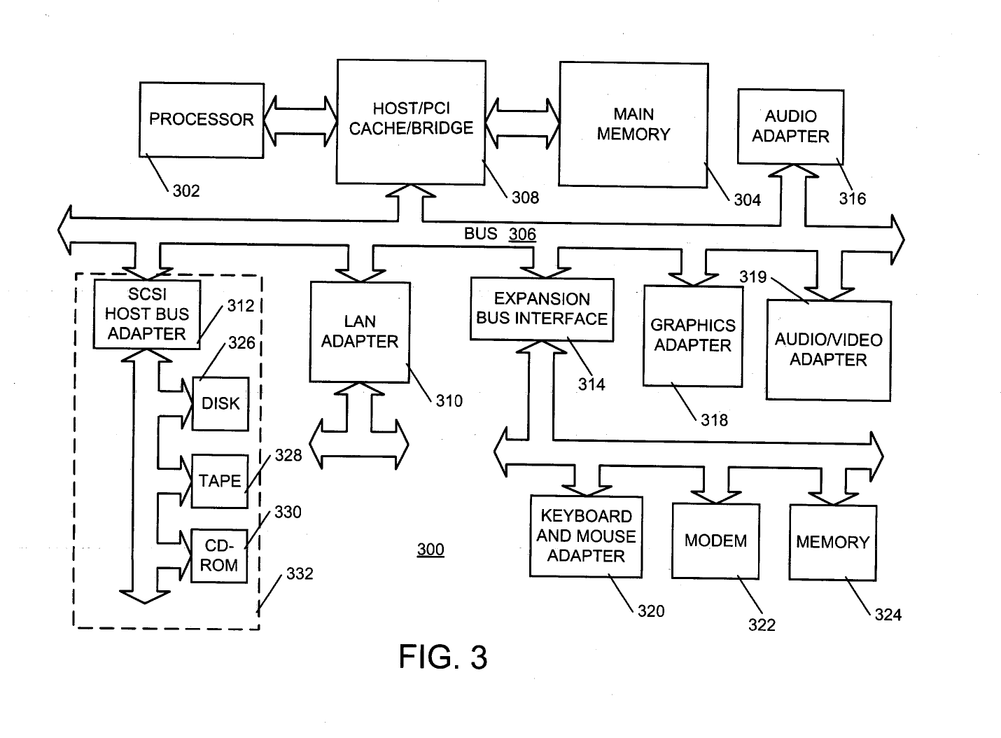

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCT bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system and method of remotely accessing a computer system through a Web browser to initiate off-hours maintenance and management accesses on network computer systems. The invention is preferably local to the server 104. Further, the present invention may reside on any data storage medium (i.e., floppy disk, compact disk, hard disk, ROM, RAM, etc.) used by a computer system.

The invention is implemented using Web Services technology. The term “Web services” describes a standardized way of integrating Web-based applications using XML (Extensible Mark-up Language), SOAP (Simple Object Access Protocol), WSDL (Web Services Description Language) and UDDI (Universal Description, Discovery and Integration) open standards over an Internet protocol backbone. XML is used to tag data, SOAP is used to transfer the data, WSDL is used to describe the services available and UDDI is used to list the different Web services that are available.

Web services are used primarily as a means for businesses to communicate with each other and with clients. They allow organizations to communicate data without revealing information regarding their IT (Information Technology) systems. Unlike traditional client/server models, such as a Web server/Web page system, Web services do not provide a user with a GUI (Graphical User Interface). Instead, Web services share business logic, data and processes through a programmatic interface across a network. Developers can then add a GUI to a Web service (such as a Web page or an executable program) to offer specific functionality to users.

Technically, Web services allow different applications from different sources to communicate with each other without time-consuming custom coding. Further, because all communication is in XML, Web services are not tied to any one operating system or programming language. For example, a Java program can interface with a PERL (Practical Extraction and Report Language) program just as Windows applications can interact with UNIX applications.

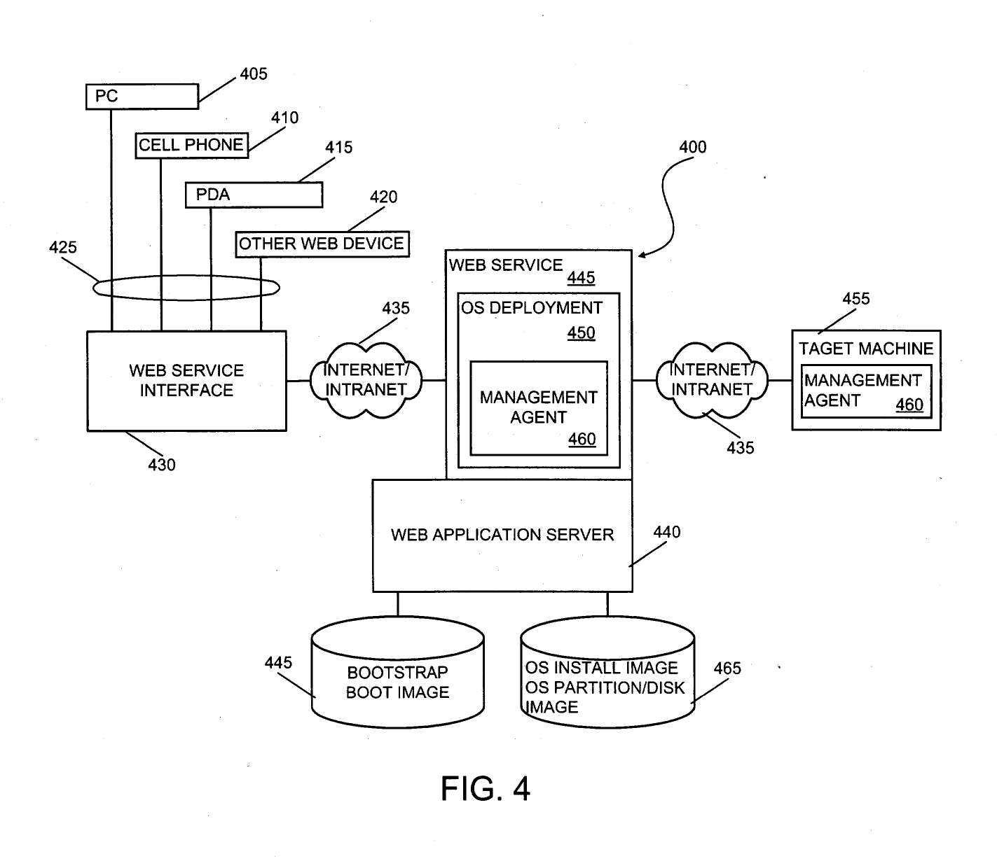

FIG. 4 is a block diagram of a computing system 400 using Web services technology in accordance with the invention. The computing system 400 may contain any number of devices (i.e., a computer system 405, a cellular phone 410, a personal digital assistant (PDA) 420 or any other Web device 420) connected to a Web service interface 430 via interface connection 425. The interface connection 425 may be a wireless connection or landline connection such as cable line, phone line etc. or a combination thereof. The Web service interface 430 may be connected to a Web application server 440 and the server 440 to a computer system 455 via Internet/Intranet 435. Note that server 440 may be the server 104 and computer system or client 455 may be any one of clients 108, 110, and 112 of FIG. 1.

Web service interface 430 is defined strictly in terms of the data that the Web Services it provides accept and generate. As alluded to above, devices 405, 410, 415 and 420 may be implemented on any platform and in any programming language as long as they generate data consistent with data used by the Web services provided by the Web Service interface 430 and are able to use the data generated by the Web services. Further a GUI such as a Web page may be used to provide the data to users in a functional manner. As is customary, a browser may be used to display the functional Web pages to the users.

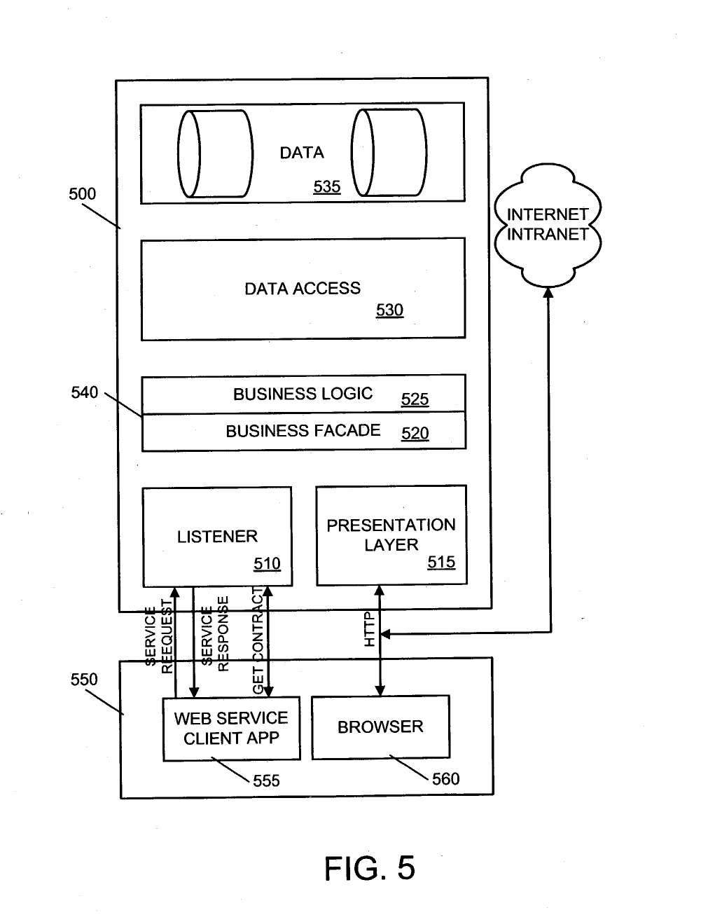

FIG. 5 illustrates a representative Web service 500 interacting with a client 550. The Web service 500 may be provided by the Web service interface 430. The client 550 may be any one of the devices 405, 410, 415 and 420 of FIG. 4. In any case, the Web service is divided into a plurality of logical layers (logical layers 510/515, 520, 540, 530 and 535). Furthest from the client 550 is the data layer 535, which stores information required by the Web Service 500. Above the data layer 535 is the data access layer 530, which presents a logical view of the physical data to the business layer 540. The data access layer 530 isolates business logic 525 from changes to the underlying stored data and thus ensures data integrity.

The business layer 540 implements business logic of the Web Service 500 and is often subdivided into two parts: the business facade 520 and the business logic 525. The business facade 520 provides a simple interface which maps directly to operations exposed by the Web Service 500. The business facade 520 uses services provided by the business logic layer 525. In a simple Web Service, all the business logic might be implemented by the business facade 520, which would interact directly with the data access layer 500.

Client applications such as Web service client application 555 interact with the Web Service listener 510. The listener 510 is responsible for receiving incoming messages containing requests for service, parsing the messages, and dispatching the request to the appropriate method on the business facade 520. The listener 510 also handles requests for contracts in order to use the Web service 500 as well as other documents about the Web Service 500.

When the Web service 500 returns a response, the listener 510 is responsible for packaging the response from the business facade 520 into a message and sending it to the client 550. If the client 550 has a browser installed thereon, service requests and responses may be handled via browser 560. In this case, the presentation layer 515 may be used in lieu of or in conjunction with the listener 510.

One of the Web services that may be provided by interface 430 in FIG. 4 is a method of contacting Web server 440 to initiate maintenance and management accesses on computer system 455. Thus, one of the actions (or responses) that the Web service may take is to contact Web server 440 through the server's Web service 445. As mentioned before this is preferably done using the HTTP protocol.

The maintenance and management accesses may include turning on the computer system 455 if it is turned off, installing a management agent 460 such as Tivoli Management Agent (TMA) and/or an operating system 465 through OS deployment 450. Further, the maintenance and management accesses may be to install application programs as well as their updates, to partition hard disks, run diagnostics etc. Depending on circumstances, the computer system 455 may be turned off after termination of a maintenance and management access.

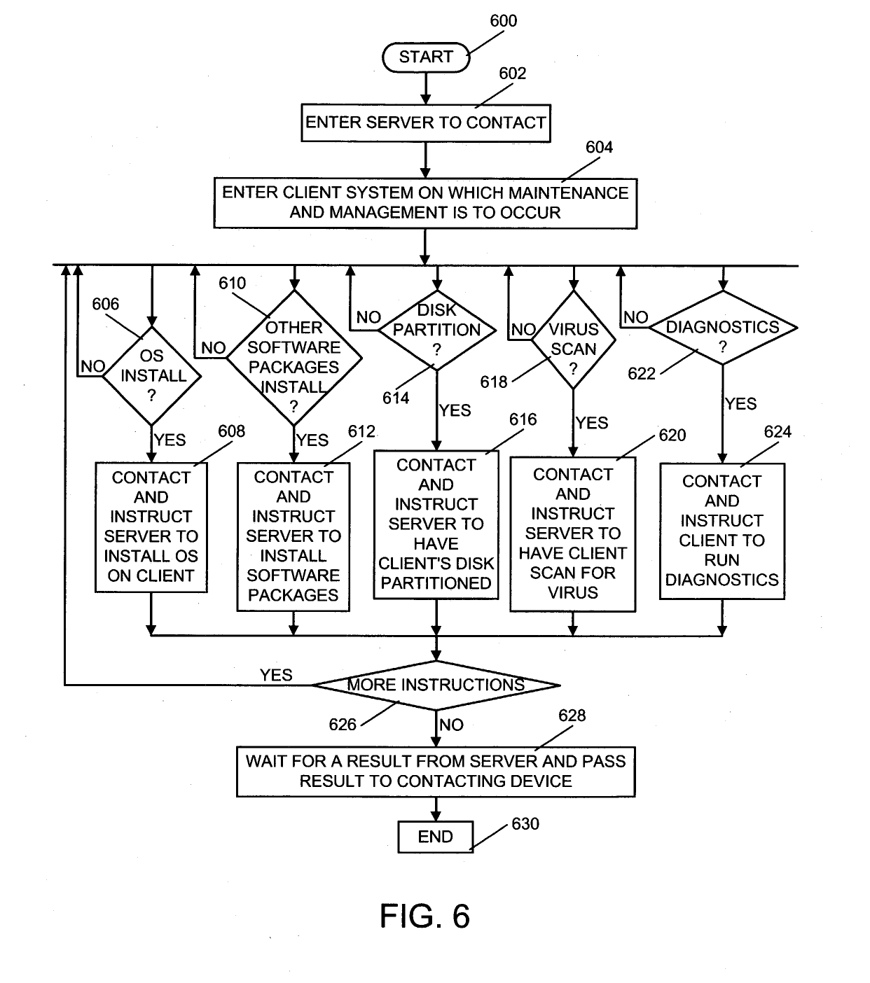

FIG. 6 is a flow chart of a process that may be used by the present invention. The process starts when a device (e.g., computer system 405, cellular phone 410, PDA 415 or other device 420) contacts the Web service interface 430 (step 600). At that point the device may be prompted to enter the server that is to be contacted as well as the client on which the maintenance and management access is to occur (steps 602 and 604). The device may again be prompted for the specific maintenance and management access (steps 606, 610, 614, 618 and 622). After the specific maintenance and management access is entered, the Web service may contact and instruct the indicated Web server (i.e., Web server 440) to perform the specified access on the indicated client (i.e., client 455) (steps 608, 612, 616, 620 and 624). The device may be asked whether there are anymore instructions that are to be passed to the indicated Web server. If so, the device will be prompted to enter the additional instructions if not the Web service may wait for a result from the Web server. Upon receiving the result, the Web service may pass the result to the device (steps 626, 628 and 630).

Note that the tasks listed in FIG. 6 (i.e., OS install, software packages install, disk partition, virus scan, run diagnostics) are not all inclusive. As can be appreciated by anyone skilled in the art, any task that may be performed by management and maintenance is well within the scope and intent of the invention. For instance, the client may be instructed to perform a disk backup, an unlisted task. Hence, the listed tasks are for illustrative purposes only and are not restrictive.

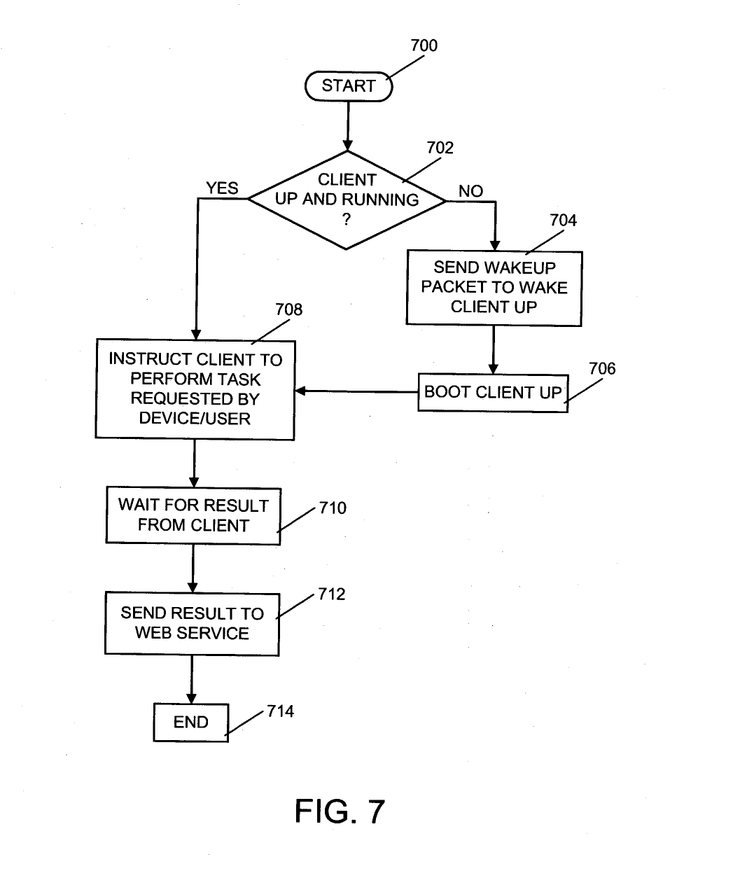

FIG. 7 is a flow chart of a process that may be used by a server in accordance with the invention. The process starts when the server 440 is contacted by the Web service 500 (step 700). The Web service 500, at that time, will pass the instructions received from the device (any one of devices 405, 410, 415 and 420) to the server 440. Then the server may determine whether the client as identified in the instructions (i.e., client 455) is up and running. If not, the server may send a wake-up packet to the client and have the client boots itself up Steps 702, 704 and 706).

As mentioned earlier, if the client 455 does not have an OS installed thereon, using the PXE boot technology as previously explained the server may download boot image 445 to the client 455. Further, the server 440 may download an OS to the client 455 using OS deployment 450.

After the client is up and running or if the client was already running, the server may then instruct the client to perform the tasks requested by the device. The server may wait for a result from the client which it will pass to the Web service before the process ends (steps 708, 710, 712 and 714).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of remotely initiating a maintenance and management access on a network computer system comprising the steps of:
remotely accessing a computer system through a device, the device using a Web service to gain access to the computer system; and
instructing the computer system to initiate the maintenance and management access on the network computer system.

2. The method of claim 1 wherein the device uses a Web browser to access the computer system.

3. The method of claim 2 wherein if the network computer system is off it is turned on by the computer system using Wake-On-LAN (WOL) technology.

4. The method of claim 3 wherein if the network computer system does not have an operating system (OS) installed thereon a pre-boot execution environment (PXE) technology is used.

5. The method of claim 4 wherein tasks such as running diagnostic tests, virus scans, install software packages and their updates etc. are performed by the network computer system.

6. The method of claim 5 wherein the network computer system provides a result to the device upon completion of a task.

7. A computer program product on a computer readable medium for remotely initiating a maintenance and management access on a network computer system comprising:
code means for remotely accessing a computer system through a device, the device using a Web service to gain access to the computer system; and
code means for instructing the computer system to initiate a remote maintenance and management access on the network computer system.

8. The computer program product of claim 7 wherein the device uses a Web browser to access the computer system.

9. The computer program product of claim 8 wherein if the network computer system is off it is turned on using Wake-On-LAN (WOL) technology.

10. The computer program product of claim 9 wherein if the network computer system does not have an operating system (OS) installed thereon pre-boot execution environment (PXE) technology is used to boot the system.

11. The computer program product of claim 10 wherein tasks such as running diagnostic tests, virus scans, install software packages and their updates etc. are performed by the network computer system.

12. The computer program product of claim 11 wherein the network computer system provides a result to the device upon completion of a task.

13. An apparatus for remotely initiating a maintenance and management access on a network computer system comprising:
means for remotely accessing a computer system through a device, the device using a Web service to gain access to the computer system; and
means for instructing the computer system to initiate the maintenance and management access on the network computer system.

14. The apparatus of claim 13 wherein the device uses a Web browser to access the computer system.

15. The apparatus of claim 14 wherein if the network computer system is off it is turned on using Wake-On-LAN (WOL) technology.

16. The apparatus of claim 15 wherein if the network computer system does not have an operating system (OS) installed thereon pre-boot execution environment (PXE) technology is used to boot the system.

17. The apparatus of claim 16 wherein tasks such as running diagnostic tests, virus scans, install software packages and their updates etc. are performed by the network computer system.

18. The apparatus of claim 17 wherein the network computer system provides a result to the device upon completion of a task.

19. A computing system for remotely initiating maintenance and management accesses on a network computer system comprising:
at least one storage device for storing code data; and
at least one processor for processing the code data to remotely access a computer system through a device, the device using a Web service to gain access to the computer system and to instruct the computer system to initiate a remote maintenance and management access on the network computer system.

20. The computing system of claim 19 wherein the device uses a Web browser to access the computer system.

21. The computing system of claim 20 wherein if the network computer system is off it is turned on by the computer system using pre-boot execution environment (PXE) technology.

22. The computing system of claim 21 wherein if the network computer system does not have an operating system (OS) installed thereon a bootstrapping technology is used to download an image of an OS to the network computer system.

23. The computing system of claim 22 wherein tasks such as running diagnostic tests, virus scans, install software packages and their updates etc. are performed by the network computer system.

24. The computing system of claim 23 wherein the network computer system provides a result to the device upon completion of a task.
